(19) United States
(12) Patent Application Publication
(10) Pub. No.: US 2026/0043217 A1
(43) Pub. Date: Feb. 12, 2026

(54) ADJUSTABLE ANGLE AUTOMATIC SUCTION INLET VALVE

(71) Applicant: Hydra-Shield Mfg. Inc., Dallas, TX (US)

(72) Inventors: J. Paul ROUSE, Dallas, TX (US); Justin P. SCHAEFER, Cedar Hill, TX (US); Grady NORTH, Greenville, TX (US); Ronald PLUMMER, Haslet (TX)

(73) Assignee: Hydra-Shield Mfg. Inc., Dallas, TX (US)

(21) Appl. No.: 19/297,358

(22) Filed: Aug. 12, 2025

Related U.S. Application Data
(60) Provisional application No. 63/682,047, filed on Aug. 12, 2024.

(51) Int. Cl. E03B 9/02; F16K 27/02

(52) U.S. Cl. CPC E03B 9/02; F16K 27/02

(57) ABSTRACT

A suction inlet valve for a fire truck pumper includes an adjustable design to permit connection at either 0 degrees or 30 degrees to a pumper so as to save space and increase utility. The suction inlet valve also includes a wider body portion that allows a size of the valve opening to be increased so as to increase throughput by approximately 80% to meet the higher capacity of newer pumpers. The suction inlet valve may include a visual indicator that indicates the position of the float of the valve, which may be representative of the flow.

### CROSS REFERENCE TO RELATED APPLICATION

This application claims the benefit of U.S. Provisional Patent Application No. 63/682,047, filed on Aug. 12, 2024, which is hereby incorporated by reference for all purposes as if fully set forth herein.

### FIELD OF THE INVENTION

The subject matter disclosed herein relates to suction inlet valves for fire truck pumpers. More particularly, this invention relates to an adjustable angle automatic suction inlet valve for fire truck pumpers usable in both hydrant and drafting operations.

### BACKGROUND OF THE INVENTION

Fire companies utilize pumper trucks to increase the pressure of hydrant water flowing through fire hoses and to pressurized water from drafting tanks. Pumpers draw water through suction valves from sources such as portable water tanks or fire hydrants.

Illustrative of widely used suction inlet valve are the Pre-Con valves available from Hydra-Shield Manufacturing, Inc. of Irving, Tex., covered by U.S. Pat. No. 5,178,183 and U.S. Pat. No. 7,040,339. The Pre-Con valve is designed to operate as an automatic flow control valve which eliminates the need for manual adjustments in reaction to water flow. In hydrant operations, the Pre-Con valve automatically opens in proportion to the flow demand and is capable of automatically balancing flow between multiple water sources. The Pre-Con valve's automatic check valve action also minimizes water hammer. When drafting from a source of water, such as a portable water tank, the check valve action of the Pre-Con valve holds prime water when flow is stopped and allows switching to a booster tank and back to drafting without flow interruption. The Pre-Con valve is an improvement over butterfly valves which it has replaced in many situations.

Pre-Con valves have continued to improve over the years with current configurations having a cone-shaped valve element connected to a valve stem which has a cam body thereon with a cam slot therein. The cam slot receives a projection from an operating shaft which projects out of the housing. The operating shaft has an operating handle thereon which is exposed to the environment and conducts heat from the chamber. If there is water in the chamber, there is an increased chance of water in the cam slot freezing disabling operation of the valve. To drain water away from the cam slot, a drain is provided in the male body portion for draining water from the chamber.

### SUMMARY OF THE INVENTION

The present disclosure is directed, in a first aspect, to an adjustable automatic inlet suction valve used with a pumper fire trucks. The inlet suction valve includes a valve housing having a male body portion and a female body portion defining a chamber, wherein the body portions are joined with a rotatable element to permit relative rotation. A first coupling is disposed on the male body portion for coupling with a source of water and a second coupling is disposed on the female body member for coupling with a pumper booster tank on the fire truck. A valve element is disposed in the first cavity, with the valve element being seated against a valve seat adjacent to the first coupling via a biasing spring. A valve support has an axial hole therethrough, with the valve support being disposed in the chamber, and the valve support having openings therethrough allowing water to flow freely. A valve stem is connected to the valve element and extends back through the axial hole in the valve support. A drain valve extends through a lower portion of the valve housing to drain water from the valve body; and a vent valve extends through the valve housing to selectively permit passage of air. The female body portion is disposed at a first angle with respect to the second coupling, and the male body portion is disposed at the first angle with respect to the rotatable element and is configured to be rotationally positioned in a first position where the first coupling is at 0 degrees relative to the second coupling and a second position 180 degrees from the first position where the first coupling is at twice the first angle relative to the second coupling.

In an embodiment, In the first angle may be 15 degrees such that the first and second couplings are configured to be rotationally positioned at either 0 degrees or 30 degrees.

In another embodiment, a positioning pin on the male body portion may be configured to engage holes 180 degrees apart from one another on the female body portion, and in certain embodiments, the positioning pin may be spring-biased.

In a further embodiment, the valve housing may include a transparent window parallel to the valve stem, and further may include an indicator element fixed at a first end to the valve element and having a second end visible through the transparent window to indicate a position of the valve element.

In yet another embodiment, the transparent window may include graduations indicative of flow rate.

In one or more embodiments, the axial hole may include a self-lubricating bushing.

In another embodiment, relative rotation between the male body portion and the female body portion may be provided by a sexless joint that permits joining in the first and second positions.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 is a schematic view showing a suction inlet valve of the instant invention drafting water from a portable water tank;

FIG. 2 is a schematic illustration showing use of a suction valve according to the instant invention being used with a fire hydrant;

FIG. 3 is a side elevation of the suction inlet valve internals according to certain aspects of the present invention;

FIG. 4 is a top elevation taken along lines 4-4 of FIG. 3;

FIG. 5 is an exploded view of the suction inlet valve of FIGS. 3 and 4;

FIG. 6 is an exterior perspective view of the adjustable angle automatic suction inlet valve of the present invention; and

FIGS. 7A and 7B are perspective views of two respective portions with a joint used to form a valve body in accordance with an embodiment of the invention.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

Embodiments of the present invention build upon and provide additional utility over the current Pre-Con suction inlet valve. In a first aspect, embodiments of the present invention include an adjustable design to permit connection at either 0 degrees or 30 degrees so as to save space and increase utility. In a second aspect, embodiments of the present invention include a wider body portion that allows a size of the valve opening to be increased so as to increase throughput by approximately 80% to meet the higher capacity of newer pumpers. In a third aspect, embodiments of the present invention include a visual indicator that indicates the position of the float of the valve, which may be representative of the flow.

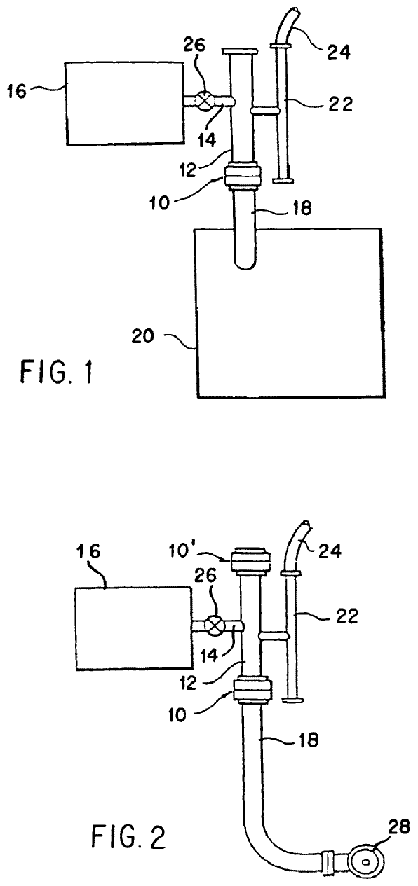

Referring now to FIG. 1, a suction inlet valve designated by the numeral 10 and configured in accordance with the principles of the instant invention, is disposed at the end of a suction pipe 12 used in a drafting operation. The suction pipe 12 is connected by a line 14 to a pumper booster tank 16 within a pumper firetruck (not shown). At its inlet end the suction valve 10 is connected by a suction hose 18 to a source of water, such as a portable water tank 20. A pump discharge manifold 22 is connected to fire hoses 24 at either or both ends. Upon opening a booster tank valve 26, water is forced at elevated pressure through the fire hoses 24.

After the pump in the firetruck (not shown) is primed and activated, the suction inlet valve 10 automatically opens at about 8 to 10 inches of vacuum. Normally, the suction inlet valve 10 automatically opens or closes in proportion to the volume of water flow.

If the water level in the tank 20 gets too low, the booster valve 26 is opened to decrease the flow resistance from the booster tank 16 allowing the suction inlet valve 10 to automatically close and thereby hold prime water in the suction hose 18. When the water level in the portable tank 20 is restored, the booster valve is closed so as to create a vacuum in the pump which automatically opens the suction inlet valve 10.

If it is desired to utilize the pumper booster tank 16 as an emergency reservoir, the suction inlet valve 10 allows the operator to switch from drafting from the portable water tank 20 to drafting from the booster tank 16 without disrupting water flow through the fire hoses 24. In the event that all discharge lines 24 are shut off, the suction inlet valve 10 automatically closes to hold prime in the suction hose 18. From the above discussion, it is seen that the suction inlet valve 10 is critical to proper operation of a pumper firetruck.

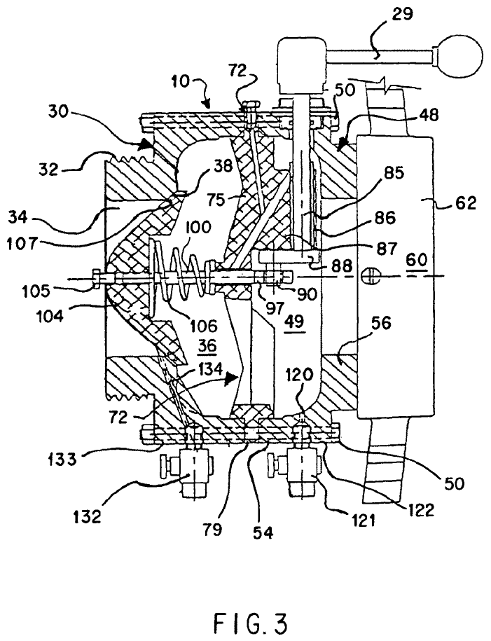

Referring now to FIG. 2 where similar elements have the same reference numerals, a pumper truck is schematically shown working from a fire hydrant 28. When the hydrant 28 is turned on, water pressure automatically opens the suction inlet valve 10. The suction inlet valve 10 opens at approximately 5 psi and will open in proportion to the flow demand. When flow is shut off through the pump discharge line 22, the suction inlet valve 10 automatically closes and, due to its novel configuration, reduces the water hammer effect in the suction hose 18 and fire hydrant 28. If it is desired to provide water from an auxiliary source, an additional inlet suction valve 10′ can be connected to the opposite end of pump suction line 12.

When working from a fire hydrant 28, it is advantageous to provide for automatic operation of the suction inlet valve 10. This is especially so when there are pair of suction inlet valves 10 connected to the same pump suction line 12. As will be explained in detail hereinafter, the suction inlet valve 10 automatically opens or closes in response to flow demand. As more discharge lines are opened from a pumper truck, or if nozzle flows increase, the valve 10 automatically opens to the limit of the control handle setting. If flow is reduced, the valve 10 automatically closes proportionally and when flow is stopped, the valve closes completely. Automatic adjustment and operation is particularly important in reducing the effects of water hammer caused by abruptly shutting off a nozzle attached to a fire hose 24.

The valve 10 also functions as a one-way flow valve. During fire hydrant operations (FIG. 2), high pressure water sources which occur during operations such as pump relay operations, are prevented by the valves 10 from overriding low pressure water sources. Moreover, multiple inlets with the valves 10 can be used to balance the water flow from several different sources. When used in the drafting mode of FIG. 1, the automatic check valve action of valve 10 holds prime water in the suction hose 18 when flow is stopped. This is very important because the system does not have to re-primed to restart the pumping operation.

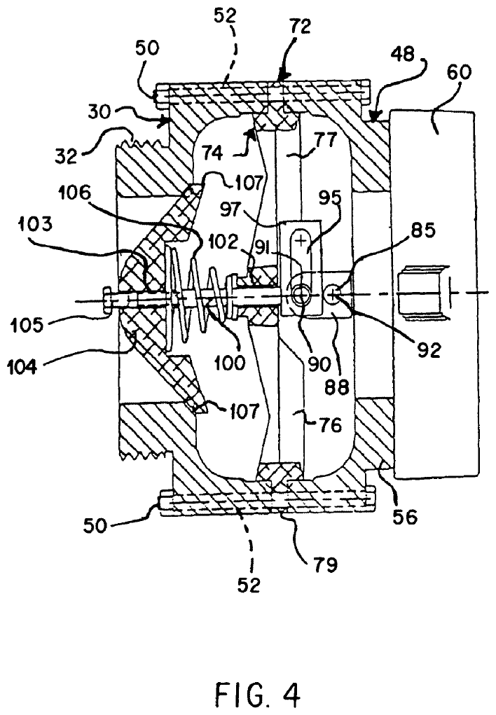

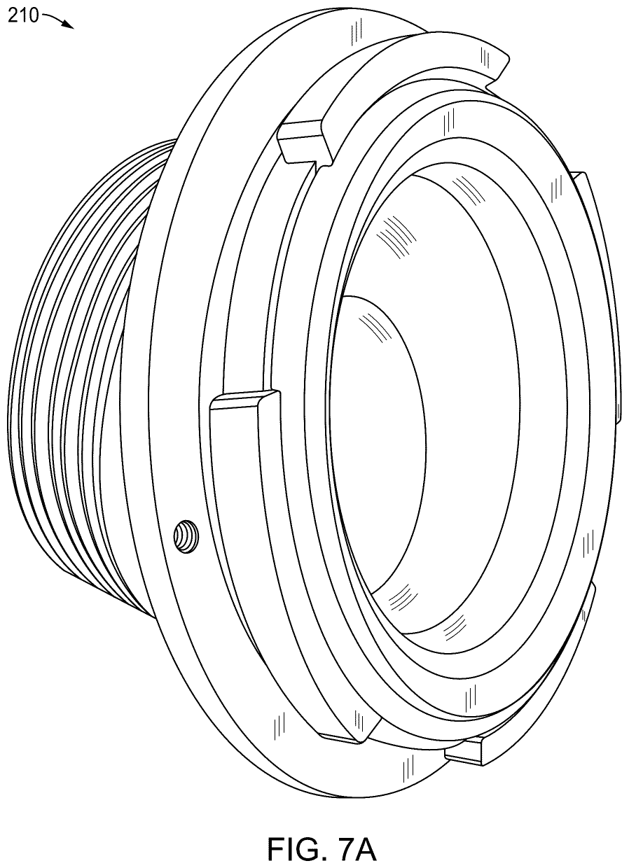

With the foregoing background in mind, an embodiment of the elements from the Pre-Con valve of U.S. Pat. No. 7,040,339 that provide the structure of the valve 10 suitable for providing automatic operation is set forth in FIGS. 3-5. Embodiments of the present invention substantially incorporate the elements disclosed in FIGS. 3-5 for the internal elements responsible for automatic operation of the suction inlet valve. However, FIGS. 3-5 do not include the additional improvements related to the adjustability of angle of the presently disclosed suction inlet valve 10, nor do they include the improvements related to an optical display of the flow/valve position, as included in FIG. 6.

Moreover, FIGS. 3-5 illustrate a manual control operating lever for manual adjustment of the valve that is omitted from embodiments of the present invention, which relies upon fully automatic operation. Referring first to FIG. 3, it is seen that the valve 10, when the operating lever 29 is omitted, opens automatically based upon water pressure acting against spring 106.

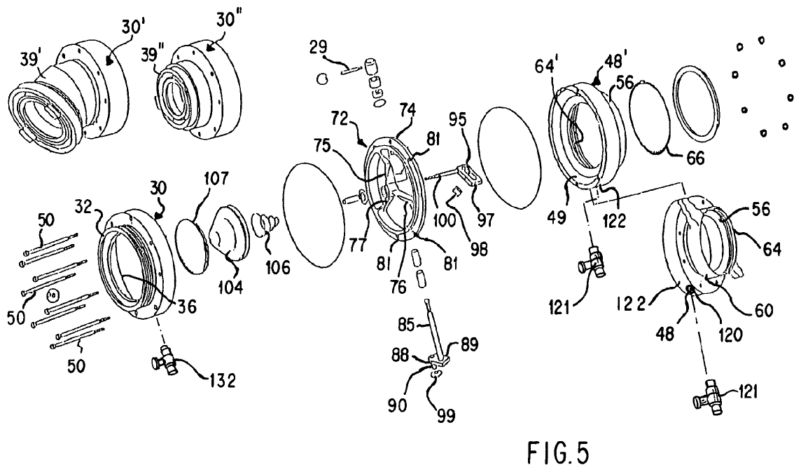

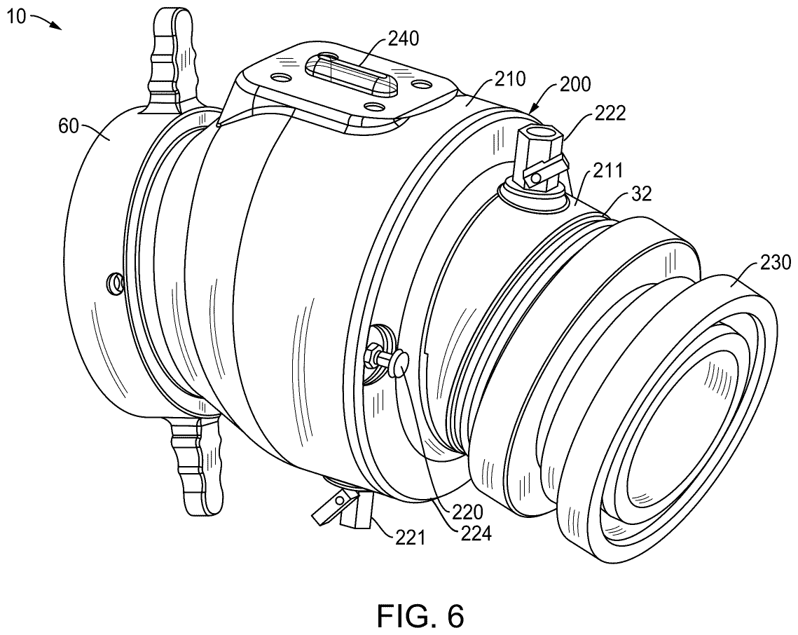

Referring now also to FIGS. 4 and 5 as well as FIG. 3, the valve 10 may include a male body portion 30 which has a threaded neck 32 onto which is threaded a suction hose such as the suction hose 18 of FIGS. 1 and 2. The neck 32 has a mouth 34 therein into which water flows. The water may be under pressure, such as the pressure applied from the fire hydrant 28 of FIG. 2, or may be unpressurized if provided by a source such as the portable water tank 20 of FIG. 1. The male body member 30 has a first cavity 36 with an annular substantially flat area 38 which joins the cavity 36 to the mouth 34. As is seen in FIG. 5, the male body member 30 may have alternate configurations 30′ and 30″ with Storz couplings 39′ and 39″, respectively. Note, however, that with the angle adjustability of the present invention as disclosed in FIG. 6, the angled Storz couplings 30′ and 39′ would no longer be needed.

Attached to the male valve body 30, is a female valve body portion 48 with a second cavity 49 therein. A plurality of bolts 50 may be received through threaded bores 52 in an annular flange 54 around the periphery of the female body member 48. The female body portion 48 has a neck 56 which has rotatably mounted thereon a threaded collar 60 which has internal threads 64. The threads 64 of the portable collar 60 threadably receive male fittings on the suction pipes 12 of FIGS. 1 and 2. In order to ensure a leakproof seal, a gasket 66 abuts the end of the neck 56 and is loosely received in an annular groove within the collar 60. Since the gasket 66 may be subject to considerable wear, it is readily replaceable.

The cavity 36 of the male valve body 30 and the cavity 49 of the female valve body 48 cooperate to define a chamber 72. In embodiments of the present disclosure, this chamber may be wider and permit approximately 80% more throughput/flow than the prior Pre-Con valve. Projecting radially inward into the chamber 72 from the female valve body 48 is a support ring 74 that includes three struts 75, 76 and 77 extending inwardly from an annular flange 79 that has an annular lip 80 with holes 81 therethrough. The bolts 50 which extend through the male and female bodies 30 and 48 pass through the holes 81 to retain the support 74 in the chamber 72 while separating the cavities 36 and 49 from one another.

A valve stem 100 passes through a bore 102 in the support ring 74. In an embodiment, the bore 102 may include a self-lubricating bushing. The valve stem 100 is slidably received in a bore 103 through a cone-shaped valve element 104 and is axially adjusted with a set screw 105 in a threaded portion of the bore 103. A coil spring 106 extends between the support 74 and the valve element 103 to bias the valve element 103 to a closed position against an annular valve seat 107 on the annular flat portion 38.

The valve 10 may be left mounted on the fire truck so that there is a tendency for the valve to freeze and become useless in cold weather. This is especially a problem with the prior Pre-Con configuration where an operating handle 29 is rigidly connected to and operating shaft 85 that is in turn integral with a crank arm 88 and pin 90 because the pin 90 conducts heat rapidly away from the slot 95 in the cam body 97. Consequently, if there is water in the slot 95, the water can rapidly freeze in the slot blocking lateral movement of the pin 90 in the slot. If lateral movement of the pin 90 is blocked then the valve element 104 can not be unseated from the valve seat 107 and the valve 10 becomes useless. If the fire truck is racing for several miles through very cold air which flows over the handle 29, heat is conducted even more rapidly away from the pin 90. If the pin 90 and slot 95 are immersed in water, water in the slot may freeze thus blocking movement of the pin in the slot even if other retained water in the cavity is not yet frozen.

In order to prevent frozen water from blocking operation of the valve 10, in a first aspect, the present invention omits the path of conduction provided by the handle 29 by omission of the manual adjustment elements. In a second aspect, a water drain 120 (FIGS. 4 and 6) with a rotating stop cock valve 121 is positioned at the bottom 122 of the cavity 49 of the female body 48 and a vent (FIG. 6) is provided to aid in the draining. Another advantage of draining the chamber is that corrosion on the walls of the chamber and on parts of the cam operating mechanism is reduced. The water drain 120 is positioned in the bottom of the cavity 49 in female body 48 because another fluid vent or drain 130 operated by a stop cock valve 132 may be positioned on the bottom 133 of the male body 30. The fluid vent or drain 130 is connected by a bore 134 to the mouth 34 of the threaded neck 32 and relieves excess pressure on the cone-shaped valve element 104.

Referring to FIG. 6, an embodiment of the adjustable angle automatic suction inlet valve 10 in accordance with the present invention is illustrated. As noted above, adjustable angle automatic suction inlet valve 10 omits the manual adjustment mechanisms of FIGS. 3-5 and is larger, with increased flow of approximately 80%, so as to meet the higher capacity of newer pumpers.

As illustrated in FIG. 6, an embodiment of adjustable angle automatic suction inlet valve 10 may include a threaded portable collar 60 with internal threads 64 (see FIGS. 3-5) for attachment to male fittings, such as on a pumper, and a threaded neck 32 for attachment to a suction hose such as 18 of FIGS. 1 and 2.

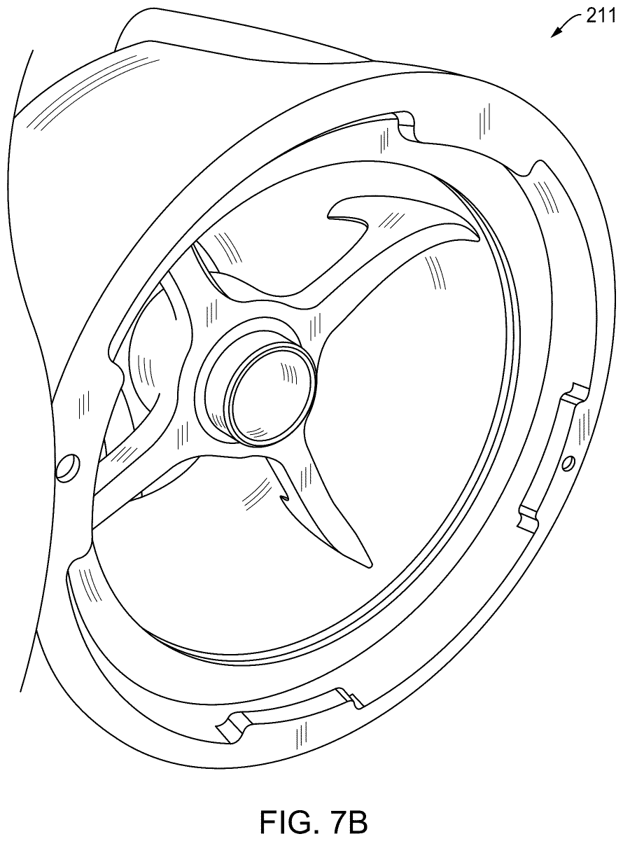

Rather than male and female body portions 30 and 48, respectively, being bolted together by bolts 50, a body 200 of valve 10 may be formed by a substantially sexless joint that attaches a portion 210 as illustrated in FIG. 7A to a portion 211 illustrated in FIG. 7B in one of a first position and a second position disposed 180 degrees from the first position.

As shown in FIG. 6, portion 210 may be disposed at an angle relative to attachment collar 60, such as approximately 15 degrees. Portion 211 may be attached thereto and include a rotatable element 224 that may be selectably-positionable between a first position (illustrated) placing threaded neck 32 at a 15 degree angle relative to the joint with the first portion 210 and a second position (not illustrated) rotated 180 degrees to be at −15 degrees relative to joint with the first portion and thus at 0 degrees relative to the attachment collar 60. In this manner, the threaded neck 32 may be disposed at either 0 degrees or 30 degrees relative to the attachment collar 60.

To provide the two positions, a spring-loaded positioning pin 220 may be provided. A user may pull the pin 220 against a biasing spring (not shown) to remove it from a first locating hole on portion 210 to permit relative rotation of portion 211 to a second locating hole positioned on portion 210 at 180 degrees from the first locating hole. Upon release of the pin 210 into the second locating hole, the relative angle of valve 10 may be fixed to the changed position.

The adjustable angle automatic suction inlet valve 10 may further include drain/vent valves 221, 222 that may be provided with stopcocks to allow selective operation, as discussed above. The adjustable angle automatic suction inlet valve 10 may also include a Storz fitting 230.

In one or more embodiments, the adjustable angle automatic suction inlet valve 10 may include a visual indicator 240. The visual indicator 240 may include an element that is attached at a first end to the cone-shaped valve element (i.e., float) 104 and moves with the float 104 along with the valve stem. A second end of the element may be positioned in a transparent window of visual indicator 240 that extends parallel to the valve stem 100 such that a position of the float 104 will be visually indicated by the second end of the element visible in the transparent window. As the flow through the valve 10 is dependent on the position of the valve/float 104, the visual indicator 240 may also be indicative of flow, and may include graduations indicative of flow rates.

One or more embodiments of the adjustable angle automatic suction inlet valve 10 may provide an extremely compact design that takes up less pump panel space. The adjustable angle automatic suction inlet valve 10 may be field adjustable from straight flow to 30-degree inlet. The adjustable angle automatic suction inlet valve 10 may automatically adjust flow depending on discharge requirements. An active position indicator shows the operator the status of valve flow in real time moving open or closed as flow demand changes.

In standard operation connected to a water supply source, the adjustable angle automatic suction inlet valve 10 may remain closed until discharge flow is started. Note that an air bleed valve is provided to remove any air in the supply line. When flow is started, the adjustable angle automatic suction inlet valve 10 may only open as much as necessary to meet flow requirements, and automatically opens and closes as discharge requirements change. If there is no flow the valve remains closed.

During drafting operation, the inlet connection would need to be changed to straight flow. This would normally require removing the 30-degree valve and changing to a straight valve inlet. The adjustable angle automatic suction inlet valve 10 may be changed from a 30-degree inlet to a straight inlet without removing the valve. After priming the suction hose, the adjustable angle automatic suction inlet valve 10 will automatically open or close according to discharge flow requirements. When there is no flow, the adjustable angle automatic suction inlet valve 10 may automatically close, which helps keep the hose primed. No manual adjustments are required.

Portable tanks have limited flow capability as water must be shuttled to the tank. As in any drafting operation, the adjustable angle automatic suction inlet valve 10 may automatically adjust to flow requirements. However, if the portable tank runs low, the operator may want to shift to booster tank operation until the next load of water arrives. This procedure can be challenging with conventional valves. The operator must simultaneously close the intake valve while opening the booster tank valve. If the timing is not perfect, loss of prime can occur. The same is true for the reverse operation-opening the intake valve while closing the booster tank valve. If there is loss of prime, discharge flow will be interrupted until prime can be reestablished. The adjustable angle automatic suction inlet valve 10 makes this procedure simple. The operator need only to open the booster tank valve. The adjustable angle automatic suction inlet valve 10 will automatically close (due to head pressure of the booster tank) and hold prime in the suction hose. When water arrives, closing the booster tank valve will cause the adjustable angle automatic suction inlet valve 10 to automatically open (due to vacuum in the pump) without any loss of prime.

When a discharge flowing water is suddenly shut off, a pressure surge (water hammer) can occur and propagate back to the pump and possibly the supply hose. Conventional intake valves have a relief valve to help prevent the pressure surge from entering the supply hose (assuming it has been properly set to the pressure rating of the hose). The adjustable angle automatic suction inlet valve 10 uses flow control to minimize pressure surges to the supply hose. As the valve 10 of the present disclosure is only open as needed for flow requirements, a very small movement of the valve float will stop the pressure surge.

The adjustable angle automatic suction inlet valve 10 of the present disclosure may also handle multiple inlets. For example: consider a pumper with a front suction connected to a fire hydrant and a second supply hose connected to a side inlet, assuming the hydrant is at 60 psi and the supply hose is at 100 psi. If flow is reduced, the higher-pressure side inlet could force water to reverse flow into the hydrant-with possible contamination of the water system. However, if a valve 10 in accordance with the present invention is installed on both intakes, it will automatically close on the low-pressure inlet and prevent back flow.

From the foregoing description, one skilled in the art can easily ascertain the essential characteristics of this invention, and without departing form the spirit and scope thereof, can make various changes and modifications of the invention to adapt it to various usages and conditions.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. An adjustable automatic inlet suction valve used with a pumper fire trucks, comprising:
a valve housing having a male body portion and a female body portion defining a chamber, the body portions being joined with a rotatable element to permit relative rotation;
a first coupling on the male body portion for coupling with a source of water and a second coupling on the female body member for coupling with a pumper booster tank on the fire truck;
a valve element in the first cavity, the valve element being seated against a valve seat adjacent to the first coupling via a biasing spring;
a valve support with an axial hole therethrough, the valve support being disposed in the chamber, the valve support having openings therethrough allowing water to flow freely;
a valve stem connected to the valve element and extending back through the axial hole in the valve support;
a drain valve through a lower portion of the valve housing to drain water from the valve body; and
a vent valve through the valve housing to selectively permit passage of air
wherein the female body portion is disposed at a first angle with respect to the second coupling,
wherein the male body portion is disposed at the first angle with respect to the rotatable element and is configured to be rotationally positioned in a first position where the first coupling is at 0 degrees relative to the second coupling and a second position 180 degrees from the first position where the first coupling is at twice the first angle relative to the second coupling.

2. The valve of claim 1, wherein the first angle is 15 degrees such that the first and second couplings are configured to be rotationally positioned at either 0 degrees or 30 degrees.

3. The valve of claim 2, wherein a positioning pin on the male body portion is configured to engage holes 180 degrees apart from one another on the female body portion.

4. The valve of claim 3, wherein positioning pin is spring-biased.

5. The valve of claim 1, wherein the valve housing includes a transparent window parallel to the valve stem, and further comprising an indicator element fixed at a first end to the valve element and including a second end visible through the transparent window to indicate a position of the valve element.

6. The valve of claim 5, wherein the transparent window includes graduations indicative of flow rate.

7. The valve of claim 1, wherein the axial hole includes a self-lubricating bushing.

8. The valve of claim 1, wherein relative rotation between the male body portion and the female body portion is provided by a sexless joint that permits joining in the first and second positions.
